(19) United States
(12) Patent Application Publication
(10) Pub. No.: US 2026/0330067 A1
(43) Pub. Date: Oct. 22, 2026

(54) HARDWARE-ATTESTED PREDICTION CONFIDENCE SCORING ENGINE

(71) Applicant: George William Bickerstaff, III, Greenwich, CT (US)

(72) Inventor: George William Bickerstaff, III, Greenwich, CT (US)

(21) Appl. No.: 19/700,287

(22) Filed: Jun. 7, 2026

(51) Int. Cl. G06F 21/64; G06F 21/62; H04L 9/32

(52) U.S. Cl. CPC G06F 21/64; G06F 21/6254; H04L 9/3218; H04L 9/3247

(57) ABSTRACT

A scoring engine executes within a hardware trusted execution environment to extract calibrated probability estimates from positions on a prediction market exchange. Position and pseudonymized identity records are confined to the environment. The engine maintains sealed accuracy profiles from decay-weighted Brier scores, computes capital-weighted conviction scores and computes a scalar information-asymmetry risk indicator from a domain z-score and pre-resolution timing concentration. A signal-weighted probability is aggregated by weighting each participant by a product of accuracy, conviction and a complement of the risk indicator, then calibrated with a confidence interval. A hardware-attestation quote signed by a hardware-rooted attestation key binds the measurement register, input and methodology commitments and the estimate, rendering code, input, methodology and output integrity independently verifiable against a hardware-vendor attestation service without the exchange operator, a result unobtainable by software-only computation. Commitments append to a tamper-evident ledger published to a public channel.

### CROSS-REFERENCE TO RELATED APPLICATIONS

This application claims the benefit of priority under 35 U.S.C. § 119(e) to U.S. Provisional Patent Application No. 64/044,023, titled “Verified Prediction Confidence Scoring Engine for Signal-Weighted Probability Extraction in Regulated Prediction Market Exchanges,” filed Apr. 20, 2026 under USPTO Customer Number 212041, the entire disclosure of which is incorporated herein by reference for all purposes. To the extent any subject matter incorporated by reference conflicts with the express disclosure of this application, the express disclosure of this application controls.

### STATEMENT REGARDING FEDERALLY SPONSORED RESEARCH OR DEVELOPMENT

Not applicable. No federally sponsored research or development was used in making the invention claimed herein.

### STATEMENT REGARDING JOINT RESEARCH AGREEMENT

Not applicable.

### REFERENCE TO SEQUENCE LISTING

Not applicable.

### INCORPORATION BY REFERENCE

No material is incorporated by reference unless expressly stated herein.

### FIELD OF THE INVENTION

The present invention relates to electronic trading data analytics and more particularly to hardware-attested, signal-weighted probability extraction systems and methods that compute verified confidence scores from heterogeneous market participant prediction activity on prediction market exchanges, wherein participant-level historical accuracy profiles, capital-weighted conviction measurements, credibility attestations and information-asymmetry risk indicators are integrated within a hardware trusted execution environment to produce calibrated, institutionally consumable probability outputs.

### BACKGROUND OF THE INVENTION

Prediction market exchanges aggregate individual participant forecasts into market prices that represent a collective probability estimate for future events. The theoretical foundation of prediction market price efficiency holds that market prices incorporate publicly available information to the extent that informed participants take positions proportional to the strength of their private signals. This efficient-market property depends on a critical assumption that institutional users have demonstrated is not met in existing prediction market infrastructure: that the marginal dollar of capital committed to a position reflects the information content of the participant who committed it.

In practice, prediction market participant populations are heterogeneous in ways that existing exchange infrastructure does not distinguish. A single dollar of capital committed by a consistently accurate domain expert carries materially different information content than a single dollar committed by a first-time retail participant with no verifiable track record. Similarly, a position representing ten percent of a participant's total available capital carries different conviction content than a position representing one-tenth of one percent of the same participant's available capital. Existing prediction market platforms, including regulated Designated Contract Market operators and unregulated alternatives, aggregate all capital equally, producing market prices that commingle signal and noise without methodological separation.

This deficiency has material consequences for institutional users of prediction market data. Hedge funds, proprietary trading firms, asset managers, corporate treasuries, macroeconomic forecasters, central banks, sovereign wealth funds and sovereign risk desks require calibrated probabilities, not raw market prices and they require confidence intervals associated with those probabilities, not point estimates. A raw market price of sixty-three percent for an economic outcome event is not operationally useful to an institutional risk desk without accompanying information about whether that price is driven by historically accurate domain experts committing concentrated capital, by a large number of retail participants committing minimal capital in aggregate, or by a small number of participants exhibiting patterns statistically consistent with non-public information access. No existing prediction market platform provides this decomposition.

The regulatory environment governing Designated Contract Markets imposes obligations on exchange operators and their institutional counterparties that raw prediction market prices do not satisfy. Institutional participants subject to Commodity Futures Trading Commission oversight and prudential regulation by banking supervisors require that the data they consume and act upon be produced by methodologically auditable processes. A probability estimate used to support a trading decision or a risk-management determination must have a documented methodology, a verifiable computation and a defensible confidence interval. Software-based probability computation that is modifiable by the exchange operator does not meet this standard. No existing prediction market data product provides hardware-attested, regulator-verifiable probability computation.

The concentration of prediction market order flow among participants who exhibit patterns statistically consistent with non-public information access creates both surveillance obligations for exchange operators and data-quality obligations for institutional data consumers. A probability estimate contaminated by information-asymmetry-informed capital overweights the signal of potentially illegal information and underweights the signal of legal participant forecasting activity. No existing system detects, flags and downweights information-asymmetry-flagged positions as a component of a confidence scoring computation performed within a hardware trusted execution environment, such that the scoring methodology is cryptographically attestable and the information-asymmetry detection is independent of exchange operator intervention.

The regulatory urgency of the foregoing deficiencies has been amplified by Commodity Futures Trading Commission enforcement activity and rulemaking affecting event contract markets. The Commission's authority to investigate and prosecute violations of the Commodity Exchange Act by participants in prediction markets, the obligation of Designated Contract Markets to monitor trading to prevent market disruption and customer harm and the applicability of the Commission's general anti-manipulation and anti-fraud provisions to prediction market contract trading and resolution, collectively create an affirmative compliance obligation for prediction market Designated Contract Markets to demonstrate that their market probability outputs are methodologically sound and not contaminated by information-asymmetry-informed capital flows. Designated Contract Market Core Principle 3 requires that contracts not be readily susceptible to manipulation; Core Principle 4 requires that Designated Contract Markets monitor trading to prevent market disruption and customer harm; and Core Principle 12 requires protection of market participants. These obligations are obligations that the present invention is specifically designed to satisfy through hardware-attested, regulator-verifiable probability computation.

Certain background technologies are known to the applicant. Reference is made by way of background to prediction market literature including Hanson's Logarithmic Market Scoring Rule, Brier's 1950 formulation of probabilistic forecast verification and subsequent calibration methods for eliciting probabilistic forecasts. Reference is further made by way of background to prior software-based approaches that weight prediction-market or forecasting participants by historical accuracy, track record, or confidence in producing an aggregate estimate and to prior approaches that detect anomalous trading by analysis of pre-event position timing or statistically improbable participant performance for surveillance purposes; such approaches operate in operator-controlled software and do not provide third-party-verifiable methodology integrity. Reference is made by way of background to hardware trusted execution environment architectures including Intel Software Guard Extensions, Intel Trust Domain Extensions, AMD Secure Encrypted Virtualization with Secure Nested Paging and ARM Confidential Compute Architecture, to remote attestation primitives including data-center attestation primitives and versioned chip endorsement key attestation and to prior uses of trusted execution environments with remote attestation to prove faithful execution of pre-approved code over private data in unrelated fields. No admission is made that any referenced technology constitutes prior art against the claims presented herein and the applicant reserves the right to address any particular reference through an Information Disclosure Statement filed in accordance with 37 C.F.R. § 1.98.

### SUMMARY OF THE INVENTION

The present invention provides verified prediction confidence scoring systems, methods and non-transitory computer-readable media for regulated prediction market exchanges and institutional consumers of prediction market data. The invention isolates a probability-aggregation computation within a hardware trusted execution environment, seals participant historical accuracy profiles to a hardware identity of that environment and binds each probability output through a hardware-rooted attestation key to a measurement of the scoring code base, to cryptographic commitments over ingested input records and to cryptographic commitments over committed scoring-methodology parameters, thereby producing probability outputs whose methodological integrity and input-record integrity are cryptographically verifiable by a third party without trust in, or participation of, an operator of the exchange.

In a first aspect, a hardware-attested prediction confidence scoring system comprises at least one hardware trusted execution environment having a hardware measurement register and a hardware-rooted attestation key configured to load a measured scoring code base; a position-intake interface and a participant-identity interface configured to deliver participant position records and participant-identity records into the hardware trusted execution environment over encrypted channels terminating at endpoints within the environment; a participant-profiling module configured to maintain, in a sealed storage region, a historical accuracy profile for each participant in which a stored accuracy score is a higher-is-better transformed measure equal to one minus a normalized mean Brier score computed on temporally decay-weighted resolution events; a conviction-weighting module configured to compute a bounded capital-weighted conviction score from a running-maximum store; an information-asymmetry risk module configured to compute a scalar information-asymmetry risk indicator combining a domain-accuracy z-score and a pre-resolution position-timing concentration score; a confidence-scoring engine configured to aggregate position-implied probabilities weighted by a product of accuracy score, conviction score and a scalar complement of the information-asymmetry risk indicator into a signal-weighted probability estimate; and an attestation module configured to produce a vendor-verifiable hardware-attestation quote binding the signal-weighted probability estimate to the measurement of the scoring code base, to the committed input records and to the committed methodology parameters.

In a second aspect, a method of producing a signal-weighted probability estimate comprises loading a measured scoring code base into a hardware trusted execution environment; ingesting participant position records and participant-identity records over encrypted channels terminating within the environment; computing temporally decay-weighted historical accuracy profiles, capital-weighted conviction scores and scalar information-asymmetry risk indicators within the environment; aggregating the foregoing into a signal-weighted probability estimate and an associated calibrated confidence interval; producing a hardware-attestation quote cryptographically binding the estimate and interval to a measurement of the scoring code base and to committed input records; and exporting the estimate, the calibrated confidence interval and the hardware-attestation quote in a form independently verifiable by a regulator or institutional data consumer without participation of an operator of the exchange.

In a third aspect, a non-transitory computer-readable medium stores program instructions that, when executed within a hardware trusted execution environment, cause performance of operations corresponding to the method of the second aspect and further support cross-platform aggregation of signal-weighted probabilities across multiple regulated prediction market exchanges and relying-party verification of the temporal integrity of a past signal-weighted probability estimate.

Further aspects include, without limitation: domain-stratified accuracy profiling enabling domain-specific participant weighting; calibration pipelines converting signal-weighted probabilities to calibrated probabilities with frequentist confidence intervals; softmax normalization for multi-outcome categorical contracts; margin-adjusted conviction scoring for participants operating through regulated futures commission merchants; zero-knowledge proof accompaniment of exported records for privacy-preserving institutional disclosure; pseudonymized participant identifiers derived from cryptographic hashes of know-your-customer attestation data; a tamper-evident methodology ledger organized as a Merkle accumulator whose root is committed to an external public commitment channel.

The foregoing summary is illustrative and is not intended to limit the scope of the claims appended hereto.

The invention provides advantages over prior approaches that no prior approach provides in combination. First, whereas software-only exchange analytics produce probability outputs verifiable only through trust in the exchange operator, the invention produces outputs whose code-base provenance, input-record integrity and methodology integrity are cryptographically verifiable by a third party without operator participation. Second, whereas prior aggregation weights all committed capital equally, the invention weights each participant by a hardware-sealed historical accuracy score, a capital-weighted conviction score and a scalar complement of an information-asymmetry risk indicator, separating signal from noise. Third, whereas prior reputation systems store credibility scores in operator-modifiable software databases, the invention seals accuracy profiles to a hardware identity such that the profiles are inaccessible and unmodifiable outside the trusted execution environment. Fourth, whereas prior approaches provide point estimates, the invention propagates finite-sample uncertainty into a calibrated confidence interval. Fifth, whereas prior approaches provide no temporal-integrity guarantee, the invention commits each output to a tamper-evident ledger whose root is published to an external public commitment channel, enabling detection of any retroactive alteration. The following table summarizes these contrasts; the advantages flow from the claimed combination and are described further in the Detailed Description.

### DEFINITIONS

As used in this specification and the appended claims, the following terms have the following meanings. Where a term is defined herein, the definition controls over any ordinary meaning. Defined terms are presented in alphabetical order.

Accuracy Score: a higher-is-better transformed measure, stored in a participant historical accuracy profile and equal to one minus a normalized mean Brier Score of the participant computed over temporally decay-weighted resolution events, such that a value of one corresponds to a perfect forecaster and the value functions directly as a positive weight multiplier.

Attestation Quote: a cryptographically signed statement produced by or on behalf of a Hardware Trusted Execution Environment that binds together at least a measurement of an executing code base, report data specified by that code base, and a hardware-vendor chain of trust verifiable by a relying party.

Brier Score: the mean squared error of probabilistic forecasts as formulated by Glenn W. Brier in 1950, wherein a lower value corresponds to superior forecast accuracy.

Calibrated Probability: a probability estimate produced by applying a calibration function to a Signal-Weighted Probability, the calibration function being derived from a historical relationship between prior estimates and subsequently observed resolution outcomes.

Commitment: a cryptographic binding to a set of data, such as a hash or Merkle root, that uniquely identifies the data without necessarily disclosing the data and that enables later verification that the data has not been altered.

Computation Interval: a bounded interval during which a particular signal-weighted probability estimate is computed within a TEE, over the records ingested during that interval and the methodology parameters in force during that interval, both of which are committed in the corresponding Attestation Quote.

Conviction Score: a bounded scalar in the range zero to one reflecting committed capital of a Participant in a designated contract relative to a historical maximum position engagement of the Participant within a configurable trailing time window.

Domain-Stratified Profile: a historical accuracy profile partitioned by contract domain category, maintaining a separate Accuracy Score and confidence interval for each contract domain category.

Hardware Trusted Execution Environment: a hardware-enforced isolated execution context supported by a processor or equivalent hardware, the integrity of whose contents is measurable by the hardware and attestable remotely through an Attestation Quote signed by a key rooted in the hardware; also referred to herein as a TEE.

Information-Asymmetry Risk Indicator: a scalar indicator computed for a Participant position by combining a domain-accuracy z-score evaluated against a population statistics store and a pre-resolution position-timing concentration score, reflecting a statistical likelihood that the position is informed by non-public information; also referred to herein as a risk indicator or iri.

Methodology Disclosure Record: a record specifying committed scoring-methodology parameters in force during a computation, including at least temporal decay function parameters, a conviction-weighting parameter, a risk-indicator z-score threshold, and a weight aggregation method identifier.

Participant: a natural person or legal entity that has submitted one or more orders or taken one or more positions on a Prediction Market Exchange contract.

Participant-Identity Record: a record enabling computation of a persistent Pseudonymized Identifier for a Participant across contracts and time periods without retaining or exposing personally identifiable information in plaintext during a computation.

Position-Implied Probability: a probability for a contract outcome implied by a Participant position, derived from the position direction and the price at which the position was taken or is held.

Prediction Market Exchange: any electronic venue on which contracts whose payout is contingent on the occurrence or non-occurrence of specified future events are offered, matched, and settled, including regulated and unregulated venues.

Proper Scoring Rule: a scoring rule under which a Participant's expected score is optimized by truthful probability reporting, including without limitation Brier scoring, logarithmic scoring, and spherical scoring.

Pseudonymized Identifier: a persistent identifier for a Participant derived from one or more cryptographic hashes of know-your-customer attestation data, computable within a TEE without retaining personally identifiable information in plaintext.

Running-Maximum Store: a data structure maintained within a TEE that records, for each Participant, a maximum observed position engagement over a configurable trailing time window, against which a current position is normalized to compute a Conviction Score.

Sealed Storage: a storage region encrypted to a hardware identity of a TEE such that its plaintext contents are accessible only to code executing within the TEE and bearing a corresponding measurement.

Signal-Weighted Probability: a probability estimate for a contract produced by aggregating, across Participants holding positions, a weighted combination of each Participant's Position-Implied Probability, Conviction Score, Accuracy Score, and Information-Asymmetry Risk Indicator.

Tamper-Evident Ledger: an append-only record, organized as a Merkle accumulator, receiving hardware-signed writes and having a root committed to an external public commitment channel, such that retroactive alteration of any recorded entry is detectable.

Zero-Knowledge Proof: a cryptographic proof that a statement is true without revealing information beyond the validity of the statement itself.

None of the terms “module,” “engine,” “interface,” “store,” “ledger,” or similar terms used in this specification or the appended claims is intended to invoke 35 U.S.C. § 112(f) or to be construed as a means-plus-function or step-plus-function limitation. Each such term refers to structure, namely program instructions executing within a hardware trusted execution environment, the data structures maintained thereby, and the hardware interactions described herein, and each is structurally defined by the trusted-execution-environment-bound algorithms, data structures, pseudocode, and hardware-architectural elements set forth in this specification and illustrated in the drawings. To the extent any such term is nonetheless construed under 35 U.S.C. § 112(f), the corresponding structure is the hardware trusted execution environment described in Section A together with the algorithm described for that term in the Detailed Description, including the pseudocode listings, and equivalents thereof.

### BRIEF DESCRIPTION OF THE DRAWINGS

The accompanying drawings, which are incorporated in and constitute a part of this specification, illustrate embodiments of the invention and, together with the description, serve to explain the principles of the invention. The drawings comprise five figures, each having five subfigures designated by a letter suffix.

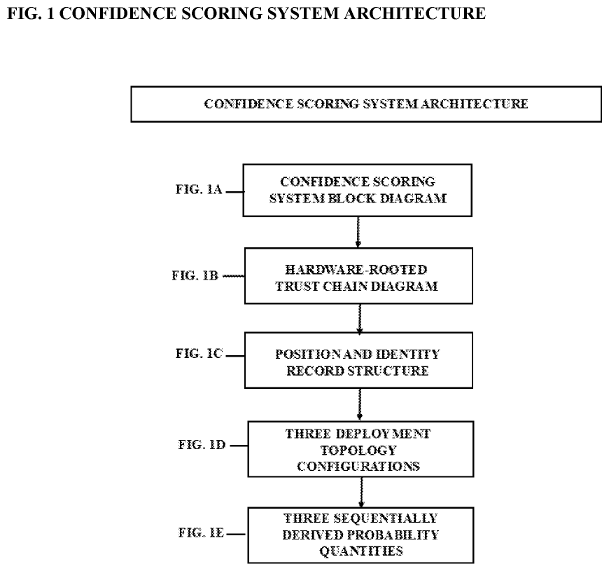

### FIG. 1A—Confidence Scoring System Block Diagram

FIG. 1A—Confidence scoring system block diagram.

### FIG. 1B—HARDWARE-ROOTED TRUST CHAIN DIAGRAM

FIG. 1B—Hardware-rooted trust chain diagram.

### FIG. 1C—POSITION AND IDENTITY RECORD STRUCTURE

FIG. 1C—Position and identity record structure.

### FIG. 1D—THREE DEPLOYMENT TOPOLOGY CONFIGURATIONS

FIG. 1D—Three deployment topology configurations.

### FIG. 1E—THREE SEQUENTIALLY DERIVED PROBABILITY QUANTITIES

FIG. 1E—Three sequentially derived probability quantities.

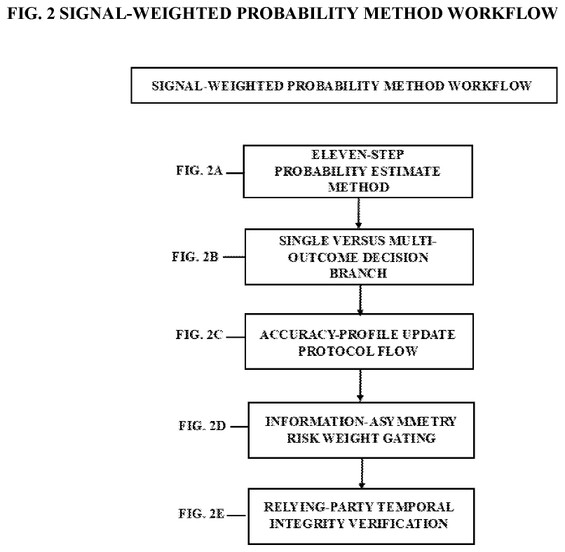

### FIG. 2A—ELEVEN-STEP PROBABILITY ESTIMATE METHOD

FIG. 2A—Eleven-step probability estimate method.

### FIG. 2B—SINGLE VERSUS MULTI-OUTCOME DECISION BRANCH

FIG. 2B—Single versus multi-outcome decision branch.

### FIG. 2C—ACCURACY-PROFILE UPDATE PROTOCOL FLOW

FIG. 2C—Accuracy-profile update protocol flow.

### FIG. 2D—INFORMATION-ASYMMETRY RISK WEIGHT GATING

FIG. 2D—Information-asymmetry risk weight gating.

### FIG. 2E—RELYING-PARTY TEMPORAL INTEGRITY VERIFICATION

FIG. 2E—Relying-party temporal integrity verification.

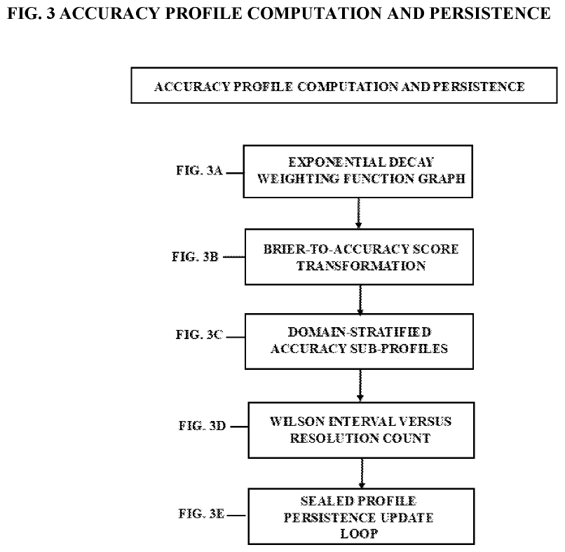

### FIG. 3A—EXPONENTIAL DECAY WEIGHTING FUNCTION GRAPH

FIG. 3A—Exponential decay weighting function graph.

### FIG. 3B—BRIER-TO-ACCURACY SCORE TRANSFORMATION

FIG. 3B—Brier-to-accuracy score transformation.

### FIG. 3C—DOMAIN-STRATIFIED ACCURACY SUB-PROFILES

FIG. 3C—Domain-stratified accuracy sub-profiles.

### FIG. 3D—WILSON INTERVAL VERSUS RESOLUTION COUNT

FIG. 3D—Wilson interval versus resolution count.

### FIG. 3E—SEALED PROFILE PERSISTENCE UPDATE LOOP

FIG. 3E—Sealed profile persistence update loop.

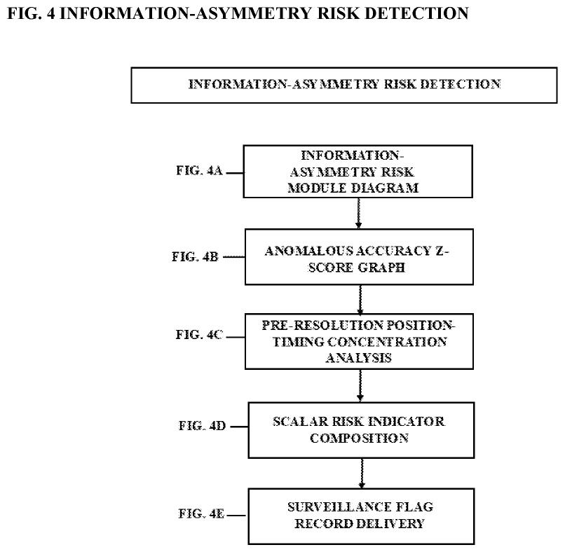

### FIG. 4A—INFORMATION-ASYMMETRY RISK MODULE DIAGRAM

FIG. 4A—Information-asymmetry risk module diagram.

### FIG. 4B—ANOMALOUS ACCURACY Z-SCORE GRAPH

FIG. 4B—Anomalous accuracy z-score graph.

### FIG. 4C—PRE-RESOLUTION POSITION-TIMING CONCENTRATION ANALYSIS

FIG. 4C—Pre-resolution position-timing concentration analysis.

### FIG. 4D—SCALAR RISK INDICATOR COMPOSITION

FIG. 4D—Scalar risk indicator composition.

### FIG. 4E—SURVEILLANCE FLAG RECORD DELIVERY

FIG. 4E—Surveillance flag record delivery.

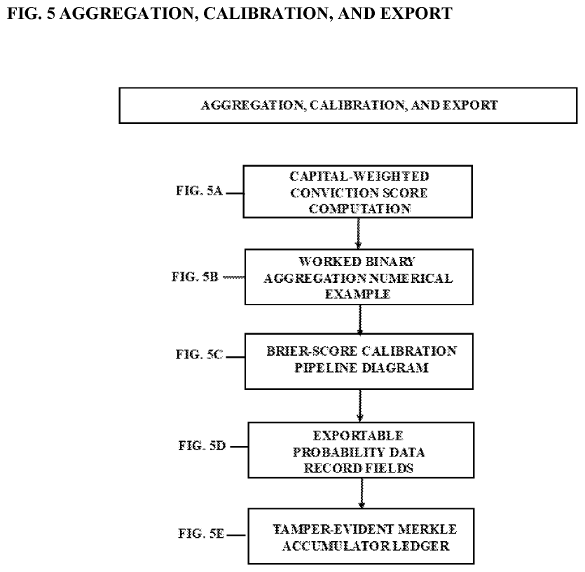

### FIG. 5A—CAPITAL-WEIGHTED CONVICTION SCORE COMPUTATION

FIG. 5A—Capital-weighted conviction score computation.

### FIG. 5B—WORKED BINARY AGGREGATION NUMERICAL EXAMPLE

FIG. 5B—Worked binary aggregation numerical example.

### FIG. 5C—BRIER-SCORE CALIBRATION PIPELINE DIAGRAM

FIG. 5C—Brier-score calibration pipeline diagram.

### FIG. 5D—EXPORTABLE PROBABILITY DATA RECORD FIELDS

FIG. 5D—Exportable probability data record fields.

### FIG. 5E—TAMPER-EVIDENT MERKLE ACCUMULATOR LEDGER

FIG. 5E—Tamper-evident Merkle accumulator ledger.

### DETAILED DESCRIPTION OF THE INVENTION

### A. Overview and Terminology

Defined terms used throughout this Detailed Description, including “prediction market exchange,” “participant,” “participant-identity record,” “accuracy score,” “signal-weighted probability,” “hardware trusted execution environment” or “TEE,” “attestation quote,” “Brier score,” and “proper scoring rule,” have the meanings set forth in the Definitions section above and are not repeated here. The following overview situates those terms within the architecture and the drawings.

As illustrated in FIG. 1C, the participant-identity record enables computation of a persistent pseudonymized identifier for a participant across multiple contracts and time periods without retaining or exposing personally identifiable information in plaintext at any point in the computation, consistent with applicable privacy law including the California Consumer Privacy Act and equivalent foreign statutes. Participants include individuals acting through regulated futures commission merchants, proprietary trading firms, market-making firms and institutional investment advisors.

As illustrated in FIG. 3B, the accuracy score stored in a historical accuracy profile is a higher-is-better transformed measure equal to one minus the participant's normalized mean Brier score: a participant with a perfect Brier score of zero has a stored accuracy score of one and a participant with a Brier score of one has a stored accuracy score of zero. This transformation enables the stored accuracy score to function directly as a positive weight multiplier in the signal-weighted probability aggregation described in Section F. The historical accuracy profile is maintained within the hardware trusted execution environment and sealed to the hardware identity of that environment.

As illustrated in FIG. 1E, the signal-weighted probability is the second of three sequentially derived quantities: the first is the raw market price, the second is the signal-weighted probability estimate produced by the confidence-scoring engine by aggregating across participants a weighted combination of each participant's position-implied probability, capital-weighted conviction score, historical accuracy score and information-asymmetry risk adjustment and the third is the calibrated probability produced by the calibration function of Section G. The attestation quote is illustrated in FIG. 1B. Non-limiting TEE examples include Intel Software Guard Extensions, Intel Trust Domain Extensions, AMD Secure Encrypted Virtualization with Secure Nested Paging, ARM Confidential Compute Architecture and IBM Secure Execution for Linux; the invention is not limited to any particular TEE technology and may use any equivalent or successor architecture providing hardware-rooted measurement, isolation and remote attestation.

### B. System Architecture

FIG. 1A depicts, in block diagram form, a verified prediction confidence scoring system according to one embodiment. The system includes a hardware trusted execution environment, a position-intake interface, a participant-identity interface, a participant-profiling module, a conviction-weighting module, an information-asymmetry risk module, a confidence-scoring engine, a calibration module, an attestation module, a tamper-evident methodology ledger and an institutional export interface. The Modules execute within the hardware trusted execution environment. The Interfaces communicate with the environment over encrypted channels terminating at endpoints within the environment. The environment contains a hardware measurement register and a hardware-rooted attestation key. In all deployment configurations, illustrated in FIG. 1D, plaintext of participant position records and participant-identity records does not traverse any channel outside the hardware trusted execution environment. The end-to-end method by which the system produces and exports a signal-weighted probability estimate, from loading of the measured scoring code base through export of the attested probability data record, is illustrated as an eleven-step flow in FIG. 2A.

As illustrated in FIG. 1B, the scoring code base, comprising at least the participant-profiling, conviction-weighting, information-asymmetry risk, confidence-scoring, calibration, and attestation modules, is measured by hardware upon instantiation, producing a measurement value held in the hardware measurement register that is incorporated into subsequent attestation quotes issued by the attestation module. The attestation quote binds together (i) the contents of the hardware measurement register, (ii) a cryptographic commitment over ingested records, (iii) a cryptographic commitment over methodology parameters and (iv) the signal-weighted probability estimate and is signed by the hardware-rooted attestation key.

As illustrated in FIG. 1C, the position-intake interface receives, from an exchange order management system or matching engine, a stream of current and historical participant position records, each comprising without limitation a participant identifier, a contract identifier, a position direction, a quantity, an average entry price, a position timestamp and a session identifier. The participant-identity interface receives participant-identity records, each comprising a pseudonymized identifier derived from cryptographic hashes of know-your-customer attestation data, a hashed funding-source identifier, a know-your-customer attestation reference, a domain-expertise credential reference, an anti-money-laundering screening status and optional futures-commission-merchant-certified margin data, in a form that does not expose personally identifiable information in plaintext outside the environment.

### C. Participant Historical Accuracy Profile Computation

The participant-profiling module, executing within the hardware trusted execution environment, maintains and updates, for each participant observed in the system, a historical accuracy profile. FIG. 3A through FIG. 3E illustrate the accuracy profile computation pipeline, including the temporal decay weighting function (FIG. 3A), the Brier-to-accuracy transformation (FIG. 3B), domain stratification (FIG. 3C), the confidence interval on resolution count (FIG. 3D) and the sealed persistence loop (FIG. 3E). Upon resolution of each prediction market contract, the module receives a resolution record comprising the contract identifier, the resolution outcome and the resolution timestamp and updates the accuracy profile of each participant who held a position in the resolved contract. The accuracy-profile update protocol executed within the environment upon each contract resolution is illustrated as a ten-step flow in FIG. 2C.

For each resolved contract resolution event, the module computes a per-resolution proper scoring rule value for the participant, reflecting the distance between the participant's implied probability at a specified pre-resolution snapshot time and the realized binary or categorical outcome. In the following pseudocode, the symbol lambda denotes the temporal decay constant described in paragraph [0053], N denotes the participant's resolved-event count and brier_i denotes the per-event Brier component; the procedure executes within the hardware trusted execution environment upon each contract resolution:
PROCEDURE UpdateAccuracyProfile(participant_id, contract_id,
resolution_outcome, snapshot_probability,
resolution_timestamp, domain_category):
//Temporal decay weight (lambda ~0.0077/day->90-day half-life)
dt<-(current_time-resolution_timestamp) in days
w<-exp(-lambda*dt)
//Brier component (lower raw value=more accurate)
brier_i<-w*(snapshot_probability-resolution_outcome)\hat{ }2
profile<-UNSEAL(participant_id)
profile.events.append({brier_i, resolution_timestamp, domain_category})
//Higher-is-better stored score; 1=perfect
raw_brier<-SUM(brier_i)/N
profile.accuracy_score<-1-raw_brier//bounded [0,1]
profile.domain_score[domain_category]<-1-domain_subset_mean(profile.events)
profile.confidence_interval<-WilsonInterval(profile.accuracy_score, N)
SEAL(participant_id, profile)
ATTEST(profile.pre_state, profile.post_state, resolution_record)

The temporal decay function applied to historical resolution events, illustrated in FIG. 3A, is a configurable exponential decay in which each resolution event's weight decays by a factor of e raised to the power of negative lambda multiplied by the time elapsed since resolution. In the exemplary embodiment, lambda equals approximately 0.0077 per day, producing a half-life of ninety days, such that a resolution event six months old contributes approximately twenty-five percent of the weight of a current event. In various embodiments, lambda ranges from approximately 0.001 to approximately 0.05 per day, corresponding to half-lives ranging from approximately fourteen days to approximately two years; in another embodiment, lambda is set to zero, producing a flat-weight lifetime accuracy score. The decay parameter is a committed scoring-methodology parameter visible to institutional consumers and regulators through the methodology disclosure record.

In a further embodiment, illustrated in FIG. 3C, the participant-profiling module maintains domain-stratified accuracy profiles, in which the participant's history is partitioned by contract domain category, including economic indicator contracts, political outcome contracts, sports outcome contracts and scientific event contracts and a separate accuracy score is maintained for each domain. Domain categories are assigned to contracts by a classification function executing within the environment. Domain-stratified accuracy scores enable the confidence-scoring engine to apply higher accuracy weight to participants whose track record in the relevant domain is strong, even if their aggregate cross-domain accuracy is moderate.

The module further maintains, for each participant, a confidence interval on the participant's accuracy score, illustrated in FIG. 3D, reflecting the statistical uncertainty arising from the finite number of resolved contracts in the participant's history. In one embodiment the confidence interval is a Wilson score interval computed from the participant's resolution count and weighted accuracy rate; in another embodiment it is produced by a bootstrap resampling procedure executed within the environment. The confidence interval is propagated through the aggregation in element to produce a confidence interval on the final signal-weighted probability estimate. As illustrated in FIG. 3E, profile persistence is implemented using a sealing mechanism that encrypts profile state to the hardware identity of the environment and stores ciphertext in a sealed profile store, such that sealed profiles cannot be accessed or modified outside the environment and periodic attestation quotes bind the sealed database state to the measurement of the scoring code base.

### D. Capital-Weighted Conviction Scoring

The conviction-weighting module, executing within the environment, computes for each participant position a capital-weighted conviction score reflecting the proportion of the participant's total available capital represented by the position being scored, normalized to a bounded scalar in the range zero to one. FIG. 5A illustrates the computation. In the following pseudocode, the symbol gamma denotes the temporal concentration coefficient described in paragraph [0057], max_pos denotes the running-maximum position over the trailing window and recency_ratio denotes the fraction of position size entered within the pre-resolution timing window:
PROCEDURE ComputeConvictionScore(participant_id, contract_id,
position_size, trailing_window_days):
max_pos<-RunningMax[participant_id][trailing_window_days]
IF max_pos>0:
raw_conviction<-min(1.0, position_size/max_pos)
ELSE:
raw_conviction<-0.5//uninformative prior for new participants
IF participant_identity.fcm_margin_data AVAILABLE:
margin_util<-position_margin/total_available_margin
raw_conviction<-0.5*raw_conviction+0.5*margin_util
recency_ratio<-late_entry_size/total_position_size
conviction_score<-raw_conviction*(1+gamma*(recency_ratio-0.5))
RETURN min(1.0, max(0.0, conviction_score))

In the exemplary embodiment, the trailing window for the running maximum is ninety days, the margin adjustment blending factor is 0.5 when futures-commission-merchant-certified margin data is available and the temporal concentration adjustment coefficient gamma is 0.2. In various embodiments the trailing window ranges from approximately thirty days to approximately seven hundred thirty days, the margin blending factor ranges from approximately 0.0 to approximately 1.0 and gamma ranges from approximately 0.0 to approximately 0.5. All parameters are committed scoring-methodology parameters recorded in the methodology disclosure record. In a further embodiment, the conviction score is computed separately for binary and multi-outcome contracts, with the multi-outcome formulation normalizing each participant's directional commitment across the full outcome simplex.

### E. Information-asymmetry Risk Detection and Position Flagging

The information-asymmetry risk module, executing within the environment, detects and flags positions exhibiting patterns statistically consistent with non-public information access. FIG. 4A depicts the module architecture, including an anomalous accuracy pattern detector, a position-timing analyzer and a combiner producing a scalar information-asymmetry risk indicator and a surveillance flag record. FIG. 4B and FIG. 4C illustrate the two detection components and FIG. 4D illustrates composition of the scalar indicator. Information-asymmetry risk flagging serves two functions: it reduces the weight assigned to flagged positions in the signal-weighted probability computation, as illustrated in FIG. 2D and it produces a separate flag record delivered to the exchange's trade surveillance system, as illustrated in FIG. 4E. The following pseudocode illustrates the indicator computation:
PROCEDURE ComputeInfoAsymmetryRiskIndicator(participant_id, contract_id,
domain, pre_resolution_window, z_threshold, timing_threshold,
alpha, beta):
//Component 1: anomalous accuracy pattern detection
domain_score<-profile[participant_id].domain_score[domain]
pop_mean, pop_std<-PopulationStats[domain]
accuracy_z<-(domain_score-pop_mean)/pop_std
accuracy_flag<-(accuracy_z>z_threshold)? 1:0//z_threshold=2.5
//Component 2: pre-resolution position timing
late_positions<-FILTER(positions[participant_id][contract_id],
entry_time>T_resolution-pre_resolution_window)
timing_score<-SUM(late_positions.size)/
SUM(positions[participant_id][contract_id].size)
//Composite scalar information-asymmetry risk indicator
iri<-min(1.0, alpha*accuracy_flag+beta*timing_score)
IF iri>HIGH_RISK_THRESHOLD:
DELIVER_SURVEILLANCE_FLAG(participant_id, contract_id, iri,
accuracy_z, timing_score, ATTEST(iri))
RETURN iri

In the exemplary embodiment, illustrated in FIG. 4B and FIG. 4C, the z-score threshold is 2.5, the pre-resolution timing window is twenty-four hours, the timing threshold is 0.6, alpha is 0.5, beta is 0.5 and the high-risk threshold is 0.7. In various embodiments the z-score threshold ranges from approximately 1.5 to approximately 4.0, the pre-resolution timing window ranges from approximately one hour to approximately one hundred sixty-eight hours, the blending coefficients alpha and beta each range from approximately 0.0 to approximately 1.0 and the high-risk threshold ranges from approximately 0.5 to approximately 0.95. All parameters are committed scoring-methodology parameters. The information-asymmetry risk module maintains a population statistics store, indexed by domain category and liquidity regime, updated within the environment upon each contract resolution and attested with each accuracy profile update. As illustrated in FIG. 2D, in one embodiment positions with information-asymmetry risk indicators above the configured high-risk threshold are excluded entirely from the signal-weighted probability computation and in another embodiment positions in a configured moderate-risk range are downweighted by a factor proportional to one minus the information-asymmetry risk indicator.

### F. Signal-weighted Probability Aggregation

The confidence-scoring engine, executing within the environment, aggregates the position-implied probabilities, accuracy scores, conviction scores and information-asymmetry risk adjustments of all contributing participants into a signal-weighted probability estimate. Because the accuracy score stored in each participant profile is a higher-is-better transformed measure, it functions directly as a positive weight multiplier. The following pseudocode illustrates the aggregation for a binary outcome contract and FIG. 2B illustrates the corresponding decision branch:
PROCEDURE ComputeSignalWeightedProbability(contract_id):
weights<-[ ]; probs<-[ ]
FOR EACH participant_id IN participants[contract_id]:
a<-profile[participant_id].accuracy_score//higher is better
c<-ComputeConvictionScore(participant_id, contract_id)
iri<-ComputeInfoAsymmetryRiskIndicator(participant_id, contract_id)
w_i<-a*c*(1-iri)//accurate, convicted, low-risk=high weight
weights.append(w_i)
probs.append(PositionImpliedProbability(participant_id, contract_id))
IF SUM(weights) >0:
swp<-SUM(weights[i]*probs[i])/SUM(weights[i])//weighted mean
ELSE:
swp<-RawMarketPrice(contract_id)//fallback: no eligible participants
IF contract_id.outcome_count>2:
swp_vector<-ComputeSignalWeightedVector(contract_id)
swp_vector<-softmax(swp_vector)//normalize to sum=1.0
RETURN swp_vector
RETURN Swp

For illustrative enablement, FIG. 5B depicts a non-limiting worked example of the weighted aggregation for a binary outcome contract having three contributing participants denoted A, B and C. Participant A has a stored accuracy score of 0.85, a conviction score of 0.80 and an information-asymmetry risk indicator of 0.10; Participant B has 0.65, 0.40 and 0.05; and Participant C has 0.50, 0.20 and 0.00. With position-implied probabilities for the YES outcome of 0.70, 0.60 and 0.40 respectively, the per-participant composite weights computed within the environment are 0.612, 0.247 and 0.100. The signal-weighted probability estimate is 0.6166 divided by 0.959, approximately 0.643, compared to an unweighted mean of 0.567. The estimate thus tilts toward the position of the participant with superior historical accuracy, higher conviction and lower information-asymmetry risk signal. The foregoing numerical values are illustrative and do not limit the scope of the claims.

In one embodiment, the aggregation is performed as a weighted arithmetic mean as shown above. In another embodiment, the aggregation is performed as a weighted median, providing robustness to outlying positions. In a further embodiment, the aggregation is performed using Bayesian model averaging, in which each participant's position is treated as evidence from a forecaster with known reliability. For categorical outcome contracts with more than two possible outcomes, the confidence-scoring engine produces a signal-weighted probability vector over all possible outcomes using softmax normalization, as illustrated in FIG. 2B.

EXAMPLE 1 (BINARY CONTRACT SCORING). The worked example of paragraph [0061] and FIG. 5B constitutes a first enabling example, in which a binary economic indicator contract is scored across three participants A, B and C. Participant A has a stored accuracy score of 0.85, a conviction score of 0.80 and an information-asymmetry risk indicator of 0.10, giving a composite weight of 0.85 multiplied by 0.80 multiplied by 0.90, equal to 0.612; Participant B has 0.65, 0.40 and 0.05, giving 0.65 multiplied by 0.40 multiplied by 0.95, equal to 0.247; and Participant C has 0.50, 0.20 and 0.00, giving 0.50 multiplied by 0.20 multiplied by 1.00, equal to 0.100. With YES-outcome position-implied probabilities of 0.70, 0.60 and 0.40 respectively, the signal-weighted probability estimate is the weight-probability inner product 0.6166 divided by the weight sum 0.959, equal to approximately 0.643, contrasted with an unweighted mean of 0.567. Applying the uncertainty propagation of paragraph [0064A] at a configured ninety-five percent coverage level yields, for this example, a calibrated probability estimate of approximately 0.643 with an illustrative confidence interval of approximately [0.58, 0.70], the interval width reflecting the finite resolution counts of the three participant accuracy profiles. The confidence-scoring engine then produces and the attestation module binds within a hardware-attestation quote, the raw market price, the signal-weighted probability estimate, the calibrated probability estimate and confidence interval, the committed methodology parameters and a commitment over the three ingested position records; the resulting record is appended as a leaf of the tamper-evident ledger and its accumulator root is published to the external public commitment channel. The foregoing numerical values are illustrative and do not limit the scope of the claims.

EXAMPLE 2 (MULTI-OUTCOME CONTRACT WITH DOMAIN STRATIFICATION). As a second enabling example, consider a categorical political-event contract having three mutually exclusive outcomes X, Y and Z, scored across two participants P1 and P2 using domain-stratified accuracy profiles for the political domain. Participant P1 has a political-domain accuracy score of 0.80, a conviction score of 0.70 and an information-asymmetry risk indicator of 0.00, yielding a composite weight of 0.80 multiplied by 0.70 multiplied by 1.00, equal to 0.560. Participant P2 has a political-domain accuracy score of 0.55, a conviction score of 0.50 and an information-asymmetry risk indicator of 0.40, yielding a composite weight of 0.55 multiplied by 0.50 multiplied by 0.60, equal to 0.165. Participant P1 holds position-implied probabilities of (0.6, 0.3, 0.1) over outcomes (X, Y, Z); Participant P2 holds (0.2, 0.5, 0.3). The weighted per-outcome sums are: X equal to 0.560 multiplied by 0.6 plus 0.165 multiplied by 0.2, equal to 0.369; Y equal to 0.560 multiplied by 0.3 plus 0.165 multiplied by 0.5, equal to 0.2505;
and Z equal to 0.560 multiplied by 0.1 plus 0.165 multiplied by 0.3, equal to 0.1055. Normalizing by the weight sum of 0.725 yields a raw signal-weighted vector of approximately (0.509, 0.346, 0.146). Application of softmax normalization with a unit temperature parameter, as described in paragraph [0062], produces a probability distribution summing to unity that preserves the ranking X greater than Y greater than Z; the temperature parameter is a committed scoring-methodology parameter. Upon resolution of the contract, the calibration function is updated within the environment as described in Section G by appending the realized outcome and the pre-resolution signal-weighted vector to the calibration training set and refitting the isotonic regression and the participant-profiling module updates the political-domain accuracy sub-profiles of P1 and P2 by the procedure of Section C. The hardware-attestation quote binds the signal-weighted probability vector, the committed temperature parameter and the committed domain-stratification parameters. In this example, because the contract concerns identifiable political actors, the institutional export interface additionally exports, with the hardware-attestation quote, a zero-knowledge proof attesting that the signal-weighted probability vector was computed on position records consistent with the committed input set, without disclosing the identities or individual position sizes of P1 and P2, as described in Section K. The foregoing numerical values are illustrative and do not limit the scope of the claims.

EXAMPLE 3 (HIGH-RISK FALLBACK AND ATTESTATION-FAILURE CASE). As a third enabling example illustrating the fallback and error-handling embodiments, consider a binary contract in which every participant holding a position is flagged with a scalar information-asymmetry risk indicator exceeding the configured high-risk threshold of 0.7, for instance due to concentrated position entry within the pre-resolution timing window. Applying the gating of Section E and FIG. 2D, the confidence-scoring engine excludes all such positions from the weighted aggregation, so that the eligible weight sum is zero. Pursuant to the fallback of Section F, the engine thereupon outputs the raw market price of the contract as the signal-weighted probability estimate and a surveillance flag record is delivered for each excluded position. In a variant of this example, after computation of a valid signal-weighted probability estimate, production of the hardware-attestation quote fails, for instance because remote attestation against the hardware-vendor attestation service cannot be completed; pursuant to the suppression embodiment of Section H and claim 6, the system suppresses export of the signal-weighted probability estimate rather than exporting an unattested value, thereby ensuring that no probability data record is released without an accompanying verifiable attestation. The foregoing values and conditions are illustrative and do not limit the scope of the claims.

### G. Calibration Pipeline and Confidence Interval Production

The calibration module, executing within the environment, converts the raw signal-weighted probability estimate produced by the engine into a calibrated probability estimate with associated confidence intervals. FIG. 5C depicts the calibration pipeline, including a calibration function and propagation of three uncertainty sources. Calibration is performed by applying a calibration function derived from the historical relationship between past signal-weighted probability estimates produced by the system and subsequently observed resolution outcomes, the calibration function being updated upon each contract resolution and maintained within the environment.

In one embodiment, the calibration function is a Platt scaling logistic regression trained on historical (signal-weighted estimate, outcome) pairs within the environment. In another embodiment, the calibration function is an isotonic regression fit to historical pairs, providing a non-parametric calibration. In a further embodiment, the calibration function is maintained separately for each contract domain category. The calibration function parameters are committed scoring-methodology parameters recorded in the methodology disclosure record. As illustrated in FIG. 5C, the confidence interval on the calibrated probability estimate is produced by propagating, through the calibration function, the uncertainty arising from (i) finite-sample uncertainty in individual participant accuracy profiles, (ii) aggregation uncertainty arising from the finite number of participants contributing positions and (iii) calibration uncertainty arising from the finite historical training set, the confidence interval being expressed as a frequentist interval with a configured coverage level.

The following pseudocode illustrates the uncertainty propagation executed within the environment to produce the calibrated confidence interval:
PROCEDURE PropagateUncertainty(swp, weights, profiles,
calib_fn, coverage_level, B):
//(i) finite-sample uncertainty per participant accuracy profile
FOR EACH participant_id IN contributors:
sigma_a[participant_id]<-WilsonHalfWidth(
profiles[participant_id].accuracy_score,
profiles[participant_id].resolution_count)
//(ii)+(iii) Monte Carlo propagation through aggregation+calibration
samples<-[ ]
FOR b IN 1.B://B=bootstrap replicates
FOR EACH participant_id IN contributors:
a_b<-sample_truncated_normal(
mean=profiles[participant_id].accuracy_score,
sd=sigma_a[participant_id], lo=0, hi=1)
w_b[participant_id]<-a_b*conviction[participant_id]
*(1-iri[participant_id])
swp_b<-SUM(w_b*probs)/SUM(w_b)
calib_b<-calib_fn.sample_posterior(swp_b) //(iii)
samples.append(calib_b)
lo<-percentile(samples, (1-coverage_level)/2)
hi<-percentile(samples, 1-(1-coverage_level)/2)
RETURN (calib_fn(swp), [lo, hi])

### H. Hardware Attestation Quote Generation

The attestation module, executing within the environment, produces hardware-attestation quotes on a configured schedule and on an event-driven basis following each production of a signal-weighted probability estimate and calibrated confidence interval. As illustrated in FIG. 1B, each attestation quote binds together, at minimum: (i) the measurement value of the scoring code base as measured by hardware; (ii) a cryptographic commitment over the set of position records and participant-identity records ingested during the covered computation; (iii) a cryptographic commitment over the scoring methodology parameters in force during the computation, including accuracy-profile decay parameters, conviction-score computation method, information-asymmetry risk thresholds and significance levels and calibration function parameters; and (iv) the signal-weighted probability estimate, calibrated probability estimate and confidence interval produced by the computation. Attestation quotes are produced in formats verifiable against the hardware vendor's attestation service.

In one embodiment, the attestation module additionally produces, for each batch of updated participant accuracy profiles produced upon a contract resolution event, an attestation quote binding the pre-update profile states, the resolution record, the score computation and the post-update profile states, providing an independently verifiable audit trail of the accuracy profile update history. Key management for the attestation quotes and for any export-layer signatures is anchored in hardware-security modules operating in accordance with Federal Information Processing Standard-3 Level 3 or equivalent certification.

More particularly and as recited in the independent claims, the hardware-attestation quote binds a live aggregation state comprising, collectively: the sealed historical accuracy profiles used as weights in the covered computation; running-maximum conviction data maintained in the running-maximum store; the information-asymmetry risk parameters in force; the commitment over the participant records ingested during the computation interval; the commitment over the scoring-methodology parameters; and the signal-weighted probability estimate produced. Because all of these elements are bound together under the single hardware-rooted signature of the attestation key and anchored to the measurement value in the hardware measurement register, modification of any one of them—the measured scoring code base, a participant record, the sealed profile state, a methodology parameter, or the output estimate—causes the relying party's verification against the hardware-vendor attestation service to fail. This binding of the complete live aggregation state, rather than of an output value alone, is what distinguishes the present invention from prior approaches: prior prediction-market scoring and prior predictor-performance scoring compute weights and outputs in operator-controlled software that a relying party cannot independently verify; and prior trusted-execution-environment attestation binds a measured code base and report data but does not bind a longitudinal, sealed, accuracy-weighted aggregation state used as live weighting input to a probability computation. The present invention binds the entire weighting-and-output state, making the methodology and its inputs, not merely the result, hardware-verifiable by any relying party without operator trust.

### I. Institutional Export Interface and Methodology Ledger

FIG. 5D depicts the exportable probability data record produced by the institutional export interface, comprising: (i) the raw market price; (ii) the signal-weighted probability estimate; (iii) the calibrated probability estimate and confidence interval; (iv) the decomposition of the signal-weighted probability by participant subgroup; (v) the risk-adjusted participant count; (vi) the hardware-attestation quote; and (vii) the methodology disclosure record specifying all committed scoring parameters. The probability data record is formatted in accordance with financial data standards accepted by institutional consumers, including ISO 20022 compliant messaging schemas and flat-file formats compatible with Bloomberg Data License and Refinitiv DataScope delivery channels.

FIG. 5E depicts the tamper-evident methodology ledger, which maintains, external to the environment but receiving only hardware-signed writes therefrom, an append-only record of signal-weighted probability estimates, calibrated probability estimates, attestation quotes and methodology disclosure records. In one embodiment, the ledger is implemented as a Merkle accumulator whose root is periodically committed to an external public commitment channel, enabling any party to verify that a probability estimate produced at a past time has not been retroactively altered. The external public commitment channel may comprise a public blockchain, a regulator-operated commitment service, or a multi-party-computed commitment maintained by a consortium of prediction market exchanges. As illustrated in FIG. 2E, a relying party verifies temporal integrity by obtaining a Merkle inclusion proof from the ledger, verifying it against the published accumulator root and verifying the attestation quote against the service, all without exchange-operator participation.

In a further embodiment, the institutional export interface produces, together with each probability data record, a zero-knowledge proof attesting that the signal-weighted probability estimate was computed on participant position records consistent with a committed input set, without disclosing the identities or individual position sizes of contributing participants. This arrangement enables institutional consumers to verify the methodological integrity of probability data without receiving trader-level information to which they may not be entitled under applicable privacy law and supports compliance with know-your-customer and anti-money-laundering obligations applicable to the exchange operator.

### J. Cross-Platform Aggregation and Longitudinal Persistence

In a further embodiment, the system receives signal-weighted probability records from corresponding systems operating on multiple prediction market exchanges covering the same or economically equivalent prediction market contracts and a cross-platform aggregation module executing within a hardware trusted execution environment aggregates the multi-exchange signal-weighted probabilities into a single normalized probability estimate, applying exchange-level credibility weights reflecting each exchange's historical signal-weighted probability calibration performance, such that exchanges whose signal-weighted probabilities have historically exhibited superior calibration receive higher weight. The participant-profiling module maintains longitudinal accuracy profiles that persist across multiple contract resolution events over a multi-year history window, as illustrated in FIG. 3E, using the sealing mechanism described in Section C such that sealed profiles are inaccessible and unmodifiable outside the environment.

### K. Privacy-Preserving and Multi-Party Extensions

In further embodiments, the invention is extended with privacy-preserving and multi-party-computation primitives. In one embodiment, cross-exchange participant accuracy profile aggregation is performed using secure multi-party computation with hardware-TEE-anchored participants, such that no single exchange operator observes the complete accuracy profile of participants who trade across multiple exchanges. In another embodiment, participant-identity records are processed using pseudonymized identifiers derived from cryptographic hashes of know-your-customer attestation data, such that the scoring computation can identify the same participant across multiple contracts without retaining personally identifiable information in plaintext, satisfying the data minimization requirements of the California Consumer Privacy Act and equivalent privacy statutes. In a further embodiment, differential-privacy noise calibrated to a configured privacy budget is applied to aggregate statistical outputs of the confidence-scoring engine before export, with the noise parameters themselves recorded in the methodology disclosure record.

### L. Computer System Environment

The invention may be practiced on any computer hardware providing the TEE properties described in Section A, illustrated in FIG. 1D. Non-limiting example configurations include single-tenant bare-metal servers with TEE-equipped processors, confidential-compute virtual machines offered by cloud infrastructure providers and hybrid deployments combining on-premises TEE-equipped servers for latency-sensitive scoring with cloud-hosted attestation-verification services. The participant accuracy profile store may be implemented on any persistent storage medium accessible within the environment through encrypted channels, subject to the sealing and update-attestation protocol described in Section C.

In one representative hardware embodiment, the system comprises one or more server-class processors providing a hardware trusted execution environment, at least sixty-four gigabytes of system memory of which a configured portion is reserved as encrypted memory for the trusted execution environment, non-volatile storage for sealed profile ciphertext, a hardware security module providing key storage in accordance with Federal Information Processing Standard-3 Level 3 or an equivalent or successor certification and one or more network interfaces over which the encrypted channels of FIG. 1A terminate at endpoints within the trusted execution environment. The scoring code base comprises machine-readable instructions stored on a non-transitory medium that, when measured and instantiated within the trusted execution environment, implement the modules. The invention is not limited to the foregoing representative hardware, which is illustrative; any hardware providing hardware-rooted measurement, isolation, sealing and remote attestation, or an equivalent or successor thereof, may be used.

### M. Best Mode

The inventor contemplates the following as the best mode of practicing the invention at the time of filing. The preferred embodiment comprises: a hardware trusted execution environment implemented on Intel Trust Domain Extensions hardware; domain-stratified historical accuracy profiles computed using Brier scoring with an exponential temporal decay function having lambda of approximately 0.0077 per day, with accuracy scores stored as the complement of the normalized mean Brier score; capital-weighted conviction scores computed using the position-to-trailing-maximum ratio with optional futures-commission-merchant-certified margin adjustment; information-asymmetry risk indicators produced by the two-component z-score and timing-concentration method described in Section E with a significance threshold z of 2.5 and a pre-resolution timing window of twenty-four hours; signal-weighted probability aggregation using the accuracy-conviction-risk composite weighting described in Section F; calibration using isotonic regression trained on the system's own historical pairs; confidence interval production using uncertainty propagation through the calibration function; and institutional export records formatted for Bloomberg Data License delivery with ISO 20022 compliant metadata. All referenced technologies are identified as the best mode as of the filing date and are not admitted to constitute prior art against the claims presented herein.

### N. Alternative Embodiments

The embodiments described above are illustrative and are not intended to limit the scope of the invention. Alternative embodiments include, without limitation: use of any proper scoring rule in place of Brier scoring, including logarithmic scoring and spherical scoring; substitution of the exponential temporal decay function with any monotonically decreasing weighting function, including step-function windows, linear decay and power-law decay; margin-adjusted and leverage-adjusted conviction scoring for participants operating through regulated futures commission merchants; multi-outcome vector probability aggregation using softmax normalization and entropy-regularized aggregation; information-asymmetry risk indicator computation using machine learning classifiers trained on labeled market-abuse enforcement histories in place of z-score and timing-concentration methods; and calibration functions updated on a rolling holdout basis rather than upon each individual resolution event. Further, the invention is not limited to prediction market exchanges; the architecture described herein is applicable to any information aggregation market, expert elicitation system, forecasting tournament, or prediction poll in which participant-level accuracy records can be maintained and applied to weight participant contributions to an aggregate probability estimate. Where numerical ranges, thresholds, or parameters are described, the invention is not limited to the specific values cited; such values are illustrative of enabling embodiments and the full scope of the claims extends to equivalent parameter selections. Where cryptographic primitives and TEE technologies are identified by name, the invention is not limited to the specifically named implementations and may be practiced with any equivalent or successor confidential computing architecture providing hardware-rooted measurement, isolation and remote attestation.

The invention is applicable internationally. In various embodiments, the regulated venue is a venue designated, registered, recognized, or authorized under the laws of a jurisdiction other than the United States and the methodology disclosure record is formatted in compliance with the applicable data-quality and methodology-documentation requirements of that jurisdiction. Nothing in this specification limits the invention to any single jurisdiction and the architecture may be deployed by, or its outputs consumed by, entities subject to the regulatory frameworks of multiple jurisdictions concurrently. The subject matter disclosed herein may be the subject of one or more international or foreign patent applications claiming priority hereto, at the election and expense of any party so entitled.

### O. Technical Problem Solved and Computer-Functional Improvement

Stated simply, the technical problem is this: software-only exchange analytics cannot prove to a third party that a probability output was computed by unmodified code, using unaltered inputs, under a committed methodology. The invention solves this problem by changing the computer system itself—binding each output to a hardware measurement register, to sealed profile storage, to a hardware-rooted attestation key and to a remotely verifiable attestation quote—so that the proof travels with the output and is checkable without trusting the operator.

The invention solves a specific technical problem that arises only in computer-implemented prediction market data systems and that has no analog in pre-computer economic activity: how may a third party who does not trust the operator of a software-based prediction market exchange and who has no direct access to the exchange's servers or to its participant records, obtain cryptographic assurance that (i) a probability output disclosed by the exchange was computed by a specific, committed methodology executing in a specific, measured code base; (ii) the probability output was computed on a specific, committed set of participant position records and participant-identity records; and (iii) neither the methodology, the inputs, nor the output was altered by the exchange operator or any other party at any time after the computation occurred. Software-only implementations of probability aggregation, however carefully audited, cannot provide cryptographic assurance of these properties to a third party, because the exchange operator retains the technical capability to modify any software-produced output prior to disclosure and retains exclusive access to the server-side records from which the output is purportedly derived.

The invention addresses this problem through the specific combination of (a) isolation of the scoring computation within a hardware trusted execution environment having a hardware measurement register and a hardware-rooted attestation key, (b) hardware-anchored cryptographic measurement of the scoring code base upon instantiation, (c) sealing of participant historical accuracy profiles to the hardware identity of the trusted execution environment such that the profiles are inaccessible outside the environment, (d) hardware-anchored cryptographic binding of each probability output to the code-base measurement, to cryptographic commitments over the participant records ingested during the computation interval and to cryptographic commitments over the scoring methodology parameters in force and (e) production of hardware-attestation quotes verifiable by any relying party against a hardware-vendor attestation service without participation of the exchange operator. The hardware measurement register, the hardware-rooted attestation key, the hardware identity to which participant profiles are sealed and the hardware-vendor attestation service are specific hardware architectural features whose technical integration with the probability-aggregation computation produces a technical effect—cryptographic third-party verifiability of methodological integrity, input-record integrity and output integrity—that is unobtainable by software-only implementations regardless of the care with which such software is audited. The invention accordingly constitutes an improvement to the functioning of computer-implemented prediction market data systems, in that it transforms the class of producible outputs of such systems from software-attested outputs verifiable only through trust in the exchange operator to hardware-attested outputs verifiable without such trust.

The improvement effected by the invention is an improvement to the functioning of a computer system, not an abstract idea implemented on a generic computer. As recognized in Enfish, LLC v. Microsoft Corp., 822F.3d 1327 (Fed. Cir. 2016), claims directed to a specific improvement in the way computers operate are not abstract; and as recognized in DDR Holdings, LLC v. Hotels. com, L.P., 773F.3d 1245 (Fed. Cir. 2014), claims whose solution is necessarily rooted in computer technology to overcome a problem specifically arising in the realm of computer systems are patent-eligible. The present claims are directed to a specific, concrete improvement—hardware-anchored third-party verifiability of the code integrity, input-record integrity, methodology integrity and output integrity of a probability computation—and recite the particular hardware-architectural elements (the hardware measurement register, the hardware-rooted attestation key, the sealed profile storage, the encrypted channels terminating within the trusted execution environment and the vendor-verifiable attestation quote) by which that improvement is achieved. Unlike the claims held abstract in Alice Corp. v. CLS Bank International, 573 U.S. 208 (2014) and Bilski v. Kappos, 561 U.S. 593(2010 ), the present claims are not directed to a fundamental economic or business practice performed on a generic computer; they are directed to a computer-integrity mechanism that produces a result—cryptographic verifiability without operator trust—that the generic computer did not previously provide. The claims do not preempt the abstract concept of weighting forecasters by track record; they are confined to a particular hardware-anchored architecture. The claimed solution is necessarily rooted in computer technology in order to overcome a problem specifically arising in the realm of computer-implemented, operator-controlled data systems, namely the inability of a relying party to verify that a disclosed numerical output was produced by unmodified code on unaltered inputs under a committed methodology. Accordingly, the claims recite significantly more than any abstract idea and are directed to a patent-eligible improvement in the operation of the system itself, a result that, as recited in each independent claim, is unobtainable by software-only computation on a generic computer. The invention improves the computer system itself by transforming an untrusted software output into a cryptographically attested, sealed and publicly verifiable data product whose integrity can be confirmed by any relying party using only the hardware vendor's attestation service.

The improvement effected by the invention is not the mere automation of probability aggregation, nor the mere application of a known trusted execution environment to a known computation. The improvement is a specific, concrete enhancement to the integrity of a computer-implemented data product: the information-asymmetry decontamination performed within the measured scoring code base provably removes signal contributed by positions statistically consistent with non-public information access, and the hardware-attestation quote binds the committed decontamination methodology together with the scoring-methodology parameters, the input commitment, and the output, so that a relying party verifies not merely that some code executed, but that the specifically committed decontamination and weighting method was applied to the committed inputs and produced the committed output. This transforms a class of data product that was previously verifiable only through trust in the exchange operator into a class of data product whose methodological integrity, input-record integrity, and output integrity are cryptographically verifiable by a third party, a concrete technical improvement to the functioning of computer-implemented prediction-market data systems that does not pre-empt the abstract concept of weighting forecasts by forecaster accuracy.

The combination of elements claimed herein is non-obvious to a person of ordinary skill in the art notwithstanding that individual components—hardware trusted execution environments, probabilistic forecast verification via proper scoring rules and market-participant credibility scoring—are individually known. Prediction market literature assumes that aggregate market prices produced by software-based matching engines are the appropriate output of a prediction market system and addresses scoring-rule truthfulness rather than cryptographic output-integrity verification; this field does not motivate a skilled artisan to reach for hardware-anchored attestation of aggregation methodology. Hardware trusted execution environment literature was developed to protect confidentiality of private inputs processed by software and to provide remote attestation for confidential-computing use cases; this field does not motivate a skilled artisan to reach for hardware-attested integrity verification of publicly disclosed statistical aggregation outputs, because the technical problem in confidential computing is protecting private data from the host operator, not providing third parties with cryptographic verification of numerical results voluntarily disclosed by the operator. Credibility-scoring and reputation-system literature addresses participant accuracy measurement in social, content and e-commerce contexts and does not motivate integration of credibility scoring with hardware-anchored output attestation in a regulated derivatives context. None of these fields, individually or collectively, would have provided a teaching, suggestion, or motivation for a skilled artisan to combine trusted-execution-environment isolation, hardware measurement and attestation, sealed persistent credibility profiles, information-asymmetry-risk-aware composite weighting, calibrated confidence-interval production and tamper-evident methodology ledger publication into the integrated architecture claimed herein. The combination produces a synergistic technical effect—cryptographic third-party verifiability of the methodological integrity of statistical aggregation outputs disclosed by an untrusted software operator to regulated institutional consumers—that is materially greater than and qualitatively distinct from, the sum of the effects that the individual components produce when applied to their respective separately-known purposes.

Three further considerations reinforce non-obviousness. First, the confidential-computing art teaches away from the claimed use for a concrete technical reason: the design objective of a trusted execution environment is to minimize the trusted computing base and to keep private inputs hidden from the host, whereas attesting publicly disclosed aggregate outputs enlarges the trusted computing base and the attestation surface by bringing the entire scoring-and-export pipeline within the measured boundary; a skilled artisan steeped in confidential computing, whose training emphasizes minimizing that boundary, would have been affirmatively discouraged from expanding it to encompass output attestation of voluntarily disclosed numerical results and would have regarded such disclosure as outside the threat model the technology was built to address. Second, the long-felt but unmet need evidenced by the institutional and regulatory requirements described in the Background—the demand of prudentially regulated consumers for probability data with documented methodology, verifiable computation and independent auditability—persisted notwithstanding the prolonged availability of each individual component technology, indicating that the claimed combination was not obvious to those of skill confronting the need. Third, the combination yields an unexpected result relative to the separate fields: it confers third-party verifiability of methodology and input integrity without requiring disclosure of the underlying confidential participant records, a property that neither software auditing nor conventional confidential computing provides and that a skilled artisan would not have predicted from the component technologies operating in their respective separate domains. A person of ordinary skill would not have been motivated to combine trusted-execution-environment attestation techniques, which are designed for confidentiality of private data, with prediction-market aggregation, which publishes aggregate outputs openly, because doing so would enlarge the trusted computing base for publicly disclosed results, precisely the opposite of the design goal of confidential-computing architectures. It is further expected and may be demonstrated by prophetic simulation against historical prediction-market data, that the claimed system produces calibrated probabilities exhibiting materially lower Brier scores than both raw market prices and unweighted aggregates of participant forecasts, an improvement in forecast accuracy attributable to the hardware-enforced accuracy-conviction-risk weighting mechanism; such results, if confirmed by testing, would constitute objective evidence of unexpected results. Applicant reserves the right to submit, during prosecution, a declaration under 37 C.F.R. § 1. from a person of skill in the art documenting the long-felt need described in the Background, the failure of software-only auditing to meet that need and the unexpected character of the foregoing result, as objective indicia of non-obviousness.

The closest known approaches, considered individually, do not render the claimed combination obvious. Approaches that weight prediction-market participants by historical accuracy or confidence and that apply proper scoring rules to past performance, operate entirely in operator-controlled software and produce outputs verifiable only through trust in the operator; they neither isolate the computation within a hardware trusted execution environment, nor seal participant profiles to a hardware identity, nor bind outputs to a hardware-rooted attestation key and accordingly cannot provide the third-party verifiability that is the technical effect of the present claims. Approaches that use a trusted execution environment with remote attestation to prove that pre-approved code faithfully executed on private data, including in regulator-facing certification contexts, address attestation of execution over private inputs in unrelated fields and do not teach participant-accuracy-weighted, conviction-weighted, information-asymmetry-adjusted signal-weighted probability aggregation, do not teach sealing of longitudinal participant accuracy profiles to a hardware identity for use as aggregation weights and do not teach binding of committed scoring-methodology parameters into the attestation for relying-party verification of methodology integrity. Approaches that detect anomalous pre-resolution position timing or statistically improbable participant win rates for surveillance purposes produce unattested software outputs and do not teach incorporation of such a signal, computed within and attested by the trusted execution environment, as a weight component of an attested probability estimate. A hypothetical combination of the foregoing—running a known accuracy-weighting aggregation inside a known trusted execution environment and adding a known surveillance signal—would not arrive at the claimed invention without impermissible hindsight, because the references provide no teaching, suggestion, or motivation to bind the aggregation methodology and its inputs into a relying-party-verifiable attestation, the combination is taught away from as described above and the resulting third-party methodology-integrity verifiability is an unexpected synergistic effect rather than the predictable sum of the separate functions. The dispositive point of distinction is that the present claims bind a complete live aggregation state—the sealed accuracy profiles, the running-maximum conviction data, the information-asymmetry risk parameters, the input and methodology commitments and the signal-weighted probability estimate—under a single hardware-rooted attestation, such that any alteration of code, records, profile state, methodology, or output is detectable by an untrusting relying party. No prediction-market scoring reference, no predictor-performance scoring reference and no trusted-execution-environment attestation reference, alone or in combination, discloses or suggests binding such a live, accuracy-weighted aggregation state into a relying-party-verifiable attestation; that specific binding is neither taught nor motivated by the art and is the feature on which patentability of the claimed combination rests.

The closest known approach on the scoring side aggregates self-reported forecaster judgments after the fact, in ordinary software, using temporal decay, differential weighting by past forecasting performance, and recalibration. That approach differs from, and would not have led a person of ordinary skill to, the present invention for at least the following reasons. First, it operates on self-reported poll forecasts rather than on capital-committed positions on a regulated exchange, and provides no guarantee of input-record integrity; the present invention ingests position and identity records into a hardware trusted execution environment over channels terminating therein, such that input integrity is cryptographically committed. Second, it contains no mechanism for detecting or decontaminating positions statistically consistent with non-public information access; the present invention provably excludes or downweights such positions within the measured scoring code base and binds the decontamination threshold into the attestation quote. Third, it provides no cryptographic binding of the scoring methodology, the inputs, or the output, and therefore no means by which a third party can verify, without trusting the party performing the aggregation, that the disclosed probability was produced by the stated methodology on the stated inputs; the present invention provides exactly that binding through a hardware-rooted attestation quote. A skilled artisan beginning from the known software aggregation approach would have had no motivation to seal persistent cross-contract accuracy profiles to a hardware identity, to perform the aggregation within a measured and attested code base, or to bind methodology commitments into a vendor-verifiable quote, because the known approach is directed to improving aggregate forecast accuracy and is indifferent to third-party cryptographic verifiability of the computation.

The claimed combination produces a synergistic technical effect unobtainable by any prior-art combination: trusted-execution-environment-sealed longitudinal accuracy profiles and information-asymmetry risk indicators are used as live, dynamic weights in real-time probability aggregation, with the resulting signal-weighted estimate bound by a hardware-rooted attestation quote to both the measured code base and the specific input records, enabling independent third-party verification without operator trust. Neither prediction-market aggregation systems nor confidential-computing attestation schemes, taken alone or in combination, provide this capability, because the former do not hardware-anchor their outputs and the latter do not aggregate accuracy-weighted participant forecasts; the technical effect emerges only from their specific integration as claimed.

### Q. Exemplary Institutional Use Case

By way of non-limiting example of downstream institutional uses enabled by the technical effect described above, a sovereign central bank risk desk operating under prudential oversight and internal model validation requirements, or a sovereign wealth fund portfolio risk system operating under analogous model risk management frameworks, may consume signal-weighted probability estimates produced by the system of the present invention for incorporation into economic forecasting models, monetary policy preparation materials, financial stability assessments and long-horizon portfolio risk projections. Such consumption requires that the underlying probability data have documented methodology, verifiable computation and independent auditability meeting the institution's own model risk management standards. The hardware-attested probability data produced by the present invention, accompanied by the methodology disclosure record and the hardware-attestation quote, can be ingested directly into the institution's model validation process and independently verified against the hardware-vendor attestation service as part of the institution's own documentation of inputs, thereby supporting compliance evidence for institutional requirements that software-only probability aggregation cannot support regardless of the auditing applied to the exchange operator's software.

Without limiting the scope of the claims, subject matter disclosed herein may be associated with one or more of the following Cooperative Patent Classification areas, identified to assist classification and search: G06Q40/04 (trading systems); G06F21/53 (protection by execution in a restricted environment) and G06F21/57 (certifying or maintaining trusted computer platforms); H04L9/32 (cryptographic mechanisms for authentication and attestation); and G06N 7/01 (probabilistic computing arrangements). The foregoing classifications are illustrative and non-limiting.

The field of search for subject matter disclosed herein includes Cooperative Patent Classification G06Q40/04 (finance and trading), G06F21/53 and G06F21/57 (protection by execution in a restricted environment and certifying or maintaining trusted computer platforms), H04L9/32 (cryptographic authentication and attestation) and G06N7/01 (probabilistic reasoning), together with non-patent literature in prediction-market aggregation, proper scoring rules, trusted-execution-environment remote attestation and market-abuse surveillance.

### R. Commercial Embodiments and Portfolio Integration

Commercial embodiments of the invention include, without limitation: delivery of hardware-attested probability data records through institutional market-data distribution channels and data-license feeds; licensing of the scoring engine to operators of regulated prediction market exchanges as a verifiable data-quality layer; and deployment as an independent verification service consumed by institutional risk desks, sovereign risk functions and central-bank economic-forecasting units that require methodology-documented, independently auditable probability inputs. In such embodiments the methodology disclosure record and the hardware-attestation quote are delivered alongside the probability data record in a format ingestible by the consumer's model-validation pipeline.

In further embodiments, the invention interoperates with a broader portfolio of hardware-anchored governance and trust-infrastructure systems whose attestations chain to a common root of trust. In such a portfolio configuration, the hardware-attestation quote produced by the present invention is verifiable by the same relying-party infrastructure used to verify attestations from other attestation-based systems, enabling a unified, cryptographically verifiable trust layer across multiple regulated-market data products. The foregoing integrations are exemplary and do not limit the scope of the claims; all implementations are licensee-led and the portfolio holder does not build systems, products, or devices.

Where features of different embodiments are described separately, the features may be combined into composite embodiments within the scope of the invention. The foregoing description is provided to enable a person of ordinary skill in the art to make and use the invention and is not intended to limit the scope of the invention, which is defined solely by the claims appended hereto and their equivalents.

What is claimed is:

1. A hardware-attested confidence scoring system for a prediction market exchange, comprising:
(a) at least one hardware trusted execution environment having a hardware measurement register and a hardware-rooted attestation key, configured to load a measured scoring code base such that contents of the hardware measurement register cryptographically bind to the loaded scoring code base upon instantiation;
(b) a position-intake interface configured to deliver participant position records and participant-identity records, comprising pseudonymized identifiers, into the at least one hardware trusted execution environment over encrypted channels terminating at endpoints therein, plaintext of the records not existing outside the at least one hardware trusted execution environment during a computation interval;
(c) a participant-profiling module within the at least one hardware trusted execution environment, configured to maintain, in sealed storage sealed to a hardware identity thereof, for each participant a historical accuracy profile having a stored accuracy score that increases with historical forecasting accuracy of the participant;
(d) a conviction-weighting module within the at least one hardware trusted execution environment, configured to compute a bounded capital-weighted conviction score for a participant position;
(e) an information-asymmetry risk module within the at least one hardware trusted execution environment, configured to compute a scalar information-asymmetry risk indicator for a participant position and to provably exclude or downweight, within the measured scoring code base, a position whose scalar information-asymmetry risk indicator exceeds a committed high-risk threshold, the committed high-risk threshold being a scoring-methodology parameter bound into the hardware-attestation quote such that removal of contaminated signal by the committed method is itself rendered independently verifiable;
(f) a confidence-scoring engine within the at least one hardware trusted execution environment, configured to compute a signal-weighted probability estimate for a designated contract as a weighted aggregation across participants holding positions therein, a weight of each participant being a product of the stored accuracy score, the bounded capital-weighted conviction score and a scalar complement, equal to one minus, of the scalar information-asymmetry risk indicator; and
(g) an attestation module within the at least one hardware trusted execution environment, configured to produce a vendor-verifiable hardware-attestation quote, signed by the hardware-rooted attestation key, that cryptographically binds a live aggregation state to the contents of the hardware measurement register, the live aggregation state comprising the sealed historical accuracy profiles, running-maximum conviction data, information-asymmetry risk parameters, a commitment over the records delivered during the computation interval, a commitment over scoring-methodology parameters and the signal-weighted probability estimate, wherein the hardware-attestation quote recites, as bound structural fields verifiable against the hardware-vendor attestation service, (i) the contents of the hardware measurement register identifying the measured scoring code base, (ii) the commitment over the records delivered during the computation interval, (iii) the commitment over scoring-methodology parameters including at least a temporal-decay parameter, a conviction-weighting parameter, the committed high-risk threshold, and a weight-aggregation method identifier, and (iv) the signal-weighted probability estimate, such that any modification of the measured scoring code base, of a participant record, of the sealed profile state, of a methodology parameter, or of the signal-weighted probability estimate produces a verification failure at the relying party, and such that code integrity, input-record integrity, methodology integrity, and output integrity of the signal-weighted probability estimate are thereby independently verifiable by the relying party without participation of, or reliance on representations by, an operator of the prediction market exchange.

2. The system of claim 1, wherein the at least one hardware trusted execution environment comprises at least one of Intel Software Guard Extensions, Intel Trust Domain Extensions, AMD Secure Encrypted Virtualization with Secure Nested Paging, ARM Confidential Compute Architecture, or an equivalent or successor confidential computing architecture providing hardware-rooted measurement, isolation and remote attestation.

3. The system of claim 1, wherein the stored accuracy score is a higher-is-better transformed measure equal to one minus a normalized mean Brier score of the participant computed on temporally decay-weighted resolution events, such that an accuracy score of one corresponds to a perfect forecaster and the accuracy score functions as a positive weight multiplier, the participant-profiling module further maintaining domain-stratified historical accuracy profiles partitioning a resolution history by contract domain category and the pseudonymized identifiers being derived from cryptographic hashes of know-your-customer attestation data.

4. The system of claim 1, wherein the conviction-weighting module computes the bounded capital-weighted conviction score as a bounded ratio of a position size of the participant in the designated contract to a maximum position size of the participant observed within a configurable trailing time window maintained in a running-maximum store within the at least one hardware trusted execution environment and applies a temporal concentration adjustment that increases the bounded capital-weighted conviction score for positions entered within a configured pre-resolution timing window.

5. The system of claim 1, wherein the information-asymmetry risk module computes the scalar information-asymmetry risk indicator by combining a domain-accuracy z-score evaluated against a population statistics store maintained within the at least one hardware trusted execution environment at a configured z-score threshold and a pre-resolution position-timing concentration score, the configured z-score threshold being a committed scoring-methodology parameter and delivers a flag record to a trade surveillance system for each participant position whose scalar information-asymmetry risk indicator exceeds a configured high-risk threshold; and wherein the confidence-scoring engine is further configured to compute a cross-platform aggregated probability estimate from signal-weighted probabilities received from multiple prediction market exchanges, weighted by each exchange's historical calibration performance and the attestation module is configured to bind the cross-platform aggregated probability estimate within the hardware-attestation quote.

6. The system of claim 1, further comprising a calibration module within the at least one hardware trusted execution environment configured to apply a calibration function comprising at least one of a Platt scaling logistic regression or an isotonic regression to produce a calibrated probability estimate and a confidence interval produced by propagating finite-sample uncertainty from participant accuracy profiles through the weighted aggregation and through the calibration function and a tamper-evident ledger configured to receive hardware-signed append-only records organized as a Merkle accumulator whose root is committed to an external public commitment channel; and wherein, when no participant position remains eligible for the designated contract, the confidence-scoring engine outputs a raw market price of the designated contract as a fallback and when production of the hardware-attestation quote fails, the system suppresses export of the signal-weighted probability estimate.

7. The system of claim 1, wherein the at least one hardware trusted execution environment comprises Intel Trust Domain Extensions hardware; the stored accuracy score is computed using Brier scoring with an exponential temporal decay function having a decay constant of approximately 0.0077 per day corresponding to a ninety-day half-life; the scalar information-asymmetry risk indicator is computed at a domain-accuracy z-score threshold of approximately 2.5 over a pre-resolution timing window of approximately twenty-four hours; the calibration function comprises an isotonic regression; and the hardware-attestation quote enables verification of code integrity, input-record integrity, methodology integrity and output integrity without operator trust, a result unobtainable by software-only computation on a generic computer.

8. A method of producing a hardware-attested signal-weighted probability estimate, the method comprising:
loading a measured scoring code base into a hardware trusted execution environment having a hardware measurement register and a hardware-rooted attestation key, such that contents of the hardware measurement register cryptographically bind to the loaded scoring code base upon instantiation;
ingesting, into the hardware trusted execution environment over encrypted channels terminating at endpoints therein, participant position records and participant-identity records comprising pseudonymized identifiers, plaintext of the records not existing outside the hardware trusted execution environment during a computation interval;
maintaining, in sealed storage sealed to a hardware identity of the hardware trusted execution environment, for each participant a historical accuracy profile having a stored accuracy score that increases with historical forecasting accuracy of the participant;
computing, within the hardware trusted execution environment, for each of a plurality of participants holding positions in a designated contract (each a contributing participant), a bounded capital-weighted conviction score and a scalar information-asymmetry risk indicator for the contributing participant position;
aggregating, within the hardware trusted execution environment, position-implied probabilities of the contributing participants into a signal-weighted probability estimate for the designated contract, a weight of each participant being a product of the stored accuracy score, the bounded capital-weighted conviction score and a scalar complement, equal to one minus, of the scalar information-asymmetry risk indicator;
producing, within the hardware trusted execution environment, a hardware-attestation quote signed by the hardware-rooted attestation key that cryptographically binds, to the contents of the hardware measurement register, a live aggregation state comprising the sealed historical accuracy profiles, running-maximum conviction data, information-asymmetry risk parameters, a commitment over the ingested records, a commitment over scoring-methodology parameters and the signal-weighted probability estimate, such that modification of the measured scoring code base, of a participant record, of the sealed profile state, of a methodology parameter, or of the signal-weighted probability estimate causes relying-party verification to fail;
exporting the signal-weighted probability estimate and the hardware-attestation quote; and
verifying, by a relying party, the hardware-attestation quote against a hardware-vendor attestation service without participation of an operator of the prediction market exchange, thereby confirming code integrity, input-record integrity, methodology integrity and output integrity of the signal-weighted probability estimate, a result unobtainable by software-only computation on a generic computer.

9. The method of claim 8, wherein the stored accuracy score is a higher-is-better transformed measure equal to one minus a normalized mean Brier score computed on temporally decay-weighted resolution events and wherein the aggregating further comprises applying a calibration function to the signal-weighted probability estimate to produce a calibrated probability estimate, propagating finite-sample uncertainty from participant accuracy profiles through the aggregating and through the calibration function to produce a calibrated confidence interval and exporting the calibrated probability estimate and the calibrated confidence interval.

10. The method of claim 8, wherein, for a designated contract having more than two possible outcomes, the aggregating further comprises computing a signal-weighted probability vector over the possible outcomes and applying softmax normalization to produce a probability distribution summing to unity and wherein the hardware-attestation quote binds the signal-weighted probability vector; and wherein, when no participant position remains eligible, the method outputs a raw market price of the designated contract as a fallback.

11. The method of claim 8, further comprising generating and exporting, with the hardware-attestation quote, a zero-knowledge proof attesting that the signal-weighted probability estimate was computed on participant position records consistent with an external commitment, without disclosing identities or individual position sizes of contributing participants; applying differential-privacy noise calibrated to a configured privacy budget to an aggregate statistical output before export; and aggregating participant accuracy profiles across multiple prediction market exchanges using secure multi-party computation among hardware-trusted-execution-environment-anchored parties such that no single exchange operator observes a complete accuracy profile of a participant trading across the multiple exchanges.

12. The method of claim 8, further comprising, upon resolution of the designated contract, updating within the hardware trusted execution environment the historical accuracy profile of each participant who held a position in the designated contract by computing a per-resolution Brier score component weighted by a temporal decay factor, updating the stored accuracy score, producing a hardware-attestation quote binding pre-update profile states, a resolution record and post-update profile states to the contents of the hardware measurement register and appending the hardware-attestation quote to a tamper-evident ledger organized as a Merkle accumulator whose root is published to an external public commitment channel.

13. The method of claim 8, further comprising delivering, to a regulatory reporting endpoint in an institutional data format, a methodology disclosure record together with the hardware-attestation quote and a commitment to a tamper-evident ledger, such that the regulatory reporting endpoint independently verifies, without reliance on representations of the operator of the prediction market exchange, that probability data delivered to institutional consumers was produced by the committed scoring methodology and has not been retroactively altered.

14. A non-transitory computer-readable medium storing program instructions that, when executed within a hardware trusted execution environment, cause the hardware trusted execution environment to perform operations comprising:
loading a measured scoring code base such that contents of a hardware measurement register of the hardware trusted execution environment cryptographically bind to the loaded scoring code base upon instantiation;
receiving, over encrypted channels terminating at endpoints within the hardware trusted execution environment, participant position records and participant-identity records comprising pseudonymized identifiers;
maintaining, in sealed storage sealed to a hardware identity of the hardware trusted execution environment, for each participant a historical accuracy profile having a stored accuracy score that increases with historical forecasting accuracy of the participant;
computing, within the hardware trusted execution environment, for each of a plurality of participants holding positions in a designated contract (each a contributing participant), a bounded capital-weighted conviction score and a scalar information-asymmetry risk indicator for the contributing participant position;
aggregating, within the hardware trusted execution environment, position-implied probabilities of the contributing participants into a signal-weighted probability estimate for the designated contract, a weight of each participant being a product of the stored accuracy score, the bounded capital-weighted conviction score and a scalar complement, equal to one minus, of the scalar information-asymmetry risk indicator;
producing a hardware-attestation quote signed by a hardware-rooted attestation key of the hardware trusted execution environment that cryptographically binds, to the contents of the hardware measurement register, a live aggregation state comprising the sealed historical accuracy profiles, running-maximum conviction data, information-asymmetry risk parameters, a commitment over the received records, a commitment over scoring-methodology parameters and the signal-weighted probability estimate, such that modification of the measured scoring code base, of a participant record, of the sealed profile state, of a methodology parameter, or of the signal-weighted probability estimate causes relying-party verification to fail; and
causing export of the signal-weighted probability estimate and the hardware-attestation quote in a form by which code integrity, input-record integrity, methodology integrity and output integrity are independently verifiable against a hardware-vendor attestation service without participation of an operator of the prediction market exchange, a result unobtainable by software-only computation on a generic computer.

15. The non-transitory computer-readable medium of claim 14, wherein the operations further comprise receiving signal-weighted probability records from at least one additional prediction market exchange covering the designated contract and producing a cross-platform aggregated probability estimate by applying exchange-level credibility weights reflecting historical calibration performance of each exchange and producing a hardware-attestation quote binding the cross-platform aggregated probability estimate to the received per-exchange records and to the exchange-level credibility weights.

16. The non-transitory computer-readable medium of claim 14, wherein the prediction market exchange operates as a regulated exchange and wherein a methodology disclosure record is formatted in compliance with applicable regulatory reporting requirements for data quality and methodology documentation.

17. The non-transitory computer-readable medium of claim 14, wherein the hardware-attestation quote comprises, in a format verifiable against the hardware-vendor attestation service: (a) a hardware measurement register value bound to the loaded scoring code base such that any modification of the scoring code base produces a different measurement register value; (b) a hardware-vendor-signed chain-of-trust certificate bound to a hardware identity of the hardware trusted execution environment; (c) a commitment over the received participant position records and participant-identity records; (d) a commitment over scoring-methodology parameters including at least a temporal decay function parameter, a conviction-weighting parameter, an information-asymmetry risk z-score threshold and a weight aggregation method identifier; (e) the signal-weighted probability estimate; and (f) a signature over the foregoing fields produced using the hardware-rooted attestation key.

18. The non-transitory computer-readable medium of claim 14, wherein the operations further comprise committing a methodology disclosure record and the hardware-attestation quote to a tamper-evident ledger organized as a Merkle accumulator whose root is periodically published to an external public commitment channel comprising at least one of a public blockchain, a regulator-operated commitment endpoint, or a consortium-operated commitment channel.

19. The non-transitory computer-readable medium of claim 18, wherein the operations further support verification by a relying party of temporal integrity of a past signal-weighted probability estimate, the verification comprising obtaining from the tamper-evident ledger a Merkle inclusion proof for a record containing the past signal-weighted probability estimate, verifying the Merkle inclusion proof against a published accumulator root obtained from the external public commitment channel, verifying the hardware-attestation quote within the record against the hardware-vendor attestation service and upon successful verification of both, confirming that the past signal-weighted probability estimate was produced by the identified scoring code base and has not been retroactively altered, the verification being performable without participation of the operator of the prediction market exchange.

20. The non-transitory computer-readable medium of claim 14, wherein the operations further comprise computing a trade-integrity telemetry signal reflecting detection of at least one of cross-account coordination, order-book manipulation, or an anomalous trade pattern, and wherein the scalar information-asymmetry risk indicator incorporates the trade-integrity telemetry signal weighted by a configured blending coefficient that is a committed scoring-methodology parameter included in the hardware-attestation quote.
